(19) United States
(12) Patent Application Publication
(10) Pub. No.: US 2022/0172467 A1
(43) Pub. Date: Jun. 2, 2022

(54) MINI DRONE AND AGBOT BASED DISTRIBUTED SYSTEM AND METHOD OF OFFERING AGRONOMICS SERVICES TO FARMERS

(71) Applicants: SHIV VERMA, CEDAR KNOLLS, NJ (US); SHAILEN VERMA, RUMSON, NJ (US)

(72) Inventors: SHIV VERMA, CEDAR KNOLLS, NJ (US); SHAILEN VERMA, RUMSON, NJ (US)

(21) Appl. No.: 17/676,127

(22) Filed: Feb. 19, 2022

Related U.S. Application Data
(60) Provisional application No. 63/151,671, filed on Feb. 20, 2021.

(51) Int. Cl. G06V 20/10; B64C 39/02; A01B 79/00

(52) U.S. Cl. CPC G06V 20/188; B64C 39/024; B64C 2201/122; B64C 2201/127; A01B 79/005

(57) ABSTRACT

In this invention a Web Server based distributed cellular system to provide 21st century total digital precision agriculture to small and uneducated poor farmers is proposed. A service model is used to avoid farmers owning any equipment and a system's provided service agent becomes on ground mentor of the farmer. The invention uses plurality of low cost mini Dynamic Remotely Operated Navigation Equipment (DRONEs), automated mini robots-size of a shoe box mini AGBOTs wirelessly connected to a remote central Web Server. The central web server system uses agricultural specialists to provide farmers 21st century technology to manage their farms and increase crop yields, save amount of fertilizers used and irrigation needed without owning any equipment. Photogrammetry and radio metric images obtained from multi spectral camera mounted on these mini DRONEs allows agronomists, and other specialists at the central server site to offer all crop management functions. Data analytics, Artificial Intelligence, AI, tools used at the remote server will provide forecast on expected yield of various crops to plan for buffer stocks, and also information to insurance companies on crops affected in case of natural disasters like hail storms, floods and droughts. And thus providing quick and timely relief to affected farmers and produce growers. The system uses Autonomous mini AGBOT DRONE with its built in AI tools to weed the farms and thus avoiding use of herbicides, costly and harmful to farmers as well our environment. The mini AGBOTs can be used with the canopy of crop plants and can analyze soil samples in the field. DRONEs provide selected spraying of fertilizer and fungicide to the crop.

### BACKGROUND

Big farmers and farm corporations with several thousands of acres of land can afford to buy their own farm machines, unmanned large DRONEs, large Autonomous Robots, AGBOTs and on site managers/agronomist to manage their farms, vineyards and fruit orchards. And these farmers are also well educated and understand how technology can help them manage. However farmer with few acres of land, or who are in majority in countries like India, are not educated. They cannot afford to own expensive smart farm equipment and tend to keep practicing farming methods used by their predecessors. And they do not have access to modern farm management practices and thus suffer from over fertilization, over irrigation, over herbicide and pesticide use. This reduces their total yield and harm the environment as well people who consume their products. In term giving rise to various diseases to general population. It is very important for all farmers to use all the technology available today to increase their yields to feed growing world population at the same time maintains our eco system.

India is one of the largest producer of grains, lentils, beans and pulses in the world with second largest arable land in the world. It is also second largest producer of fruits in the world. Average Indian farmer owns less than two hectares or five acres of land. They are the poorest in the country and their crop is the main source of their income to survive. And their income is not enough to provide a decent quality of life to themselves and their family. Their children don't get educated as they are used as labor by the family in farming and lot of them drop out of school very early in the primary education. And this cycle has been repeated from generation to generations. And their economic conditions have not changed much. And their agricultural practices have not changed much. And they spend their farm income on over fertilizing, use of herbicides, pesticides without seeing any changes in the crop yields. The system in the invention frees up farmer's family from daily labor on the farm and allows them to pursue other careers to supplement their income.

This invention provides all the modern tools and methods for small farmers in India, and other parts of the world to increase their income by providing them access to latest technology, methods, and specialists in agriculture. And transform their traditional agriculture practices to digital precision agriculture methods. Farmers can improve their quality of life and help country meet food challenges.

### SUMMARY

In this invention a distributed cellular system to provide total farming services to small farmers is proposed. The invention uses low cost mini DRONEs and mini AGBOTs. The system uses a service model to provide farmers with 21st century technology to manage their farms and increase their crop yields, save amount of fertilizers used and irrigation needed without owning or operating any equipment. Farm land area in a village is covered by clusters of hexagon or circular cells seven to ten kilo meters in radius. Invention uses state of art relatively inexpensive mini drones for imaging, spraying and weeding. They are housed in the center of each cell, called Drone Pod Station, and supervised by a computer literate Farmer's Service Agent, who becomes a mentor to the farmers. All drones are connected to a central server via a broadband network. Their function is autonomous once down loaded with the task and map. Photogrammetry and radio metric images obtained from multi spectral camera mounted on these DRONEs allows agronomists, other specialists at the central Agronomics server site to offer all crop management services. Artificial Intelligence, AI, tools used by System will provide Government to forecast on expected yield of various crops to plan for buffer stocks, and also information to insurance companies on crops affected in case of natural disasters like hail storms, floods and droughts. And thus providing quick and timely relief to affected farmers and produce growers. The system uses Autonomous mini AGBOT rover drones with its built in AI tools to weed the farms and thus avoiding use of herbicides, costly and harmful to farmers as well our environment. The mini AGBOT rovers can be used even with the canopy of crop plants and can analyze soil samples in the field. DRONEs provide selected spraying of fertilizer and fungicide of crop.

### BRIEF DESCRIPTION OF DRAWINGS

The disclosure is illustrated by way of example, and not by the way of limitations in the figure of accompanying drawings in which like numerals are used to refer similar elements.

FIG. 1(a) is a block diagram of proposed system of invention.

FIG. 1(b) is a block diagram of various drones used at the Drone Pod Stations.

FIG. 1(c) is a expanded block diagram of the proposed system.

FIG. 2 is a block diagram of how various system drone components are connected to the Agronomics Web Server and remotely operated by the operators.

FIG. 3 is a block diagram of various applications running at the Web Server

### DETAILED DESCRIPTIONS

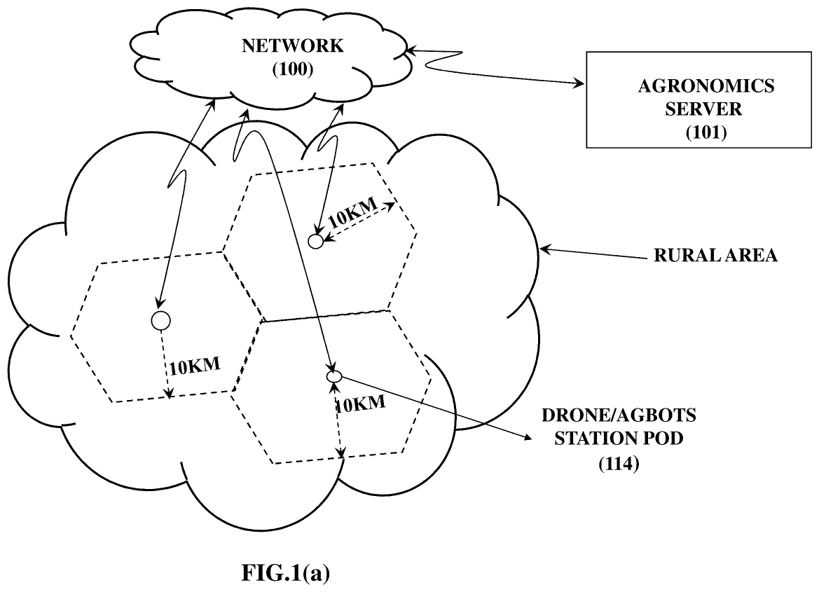

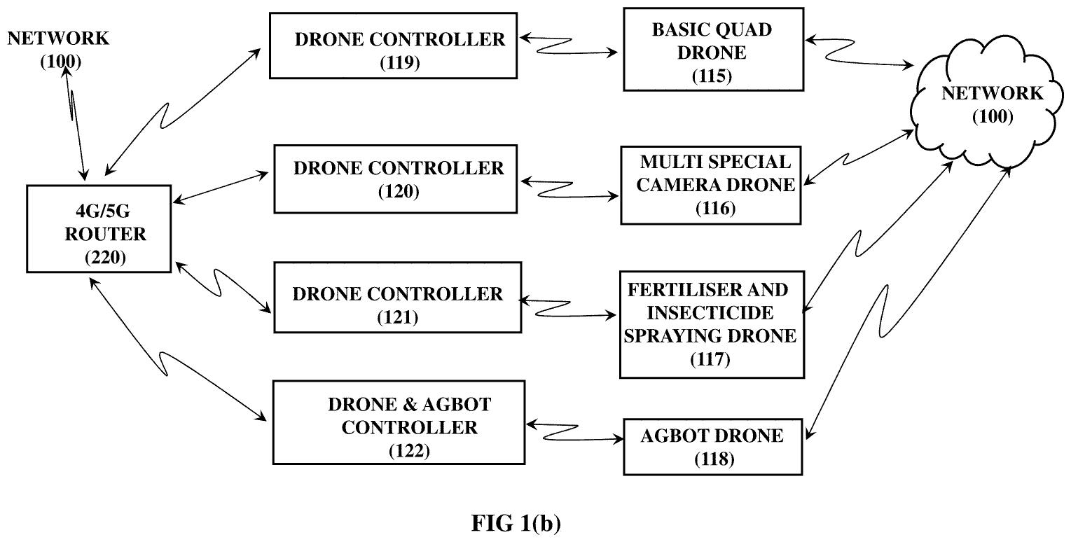

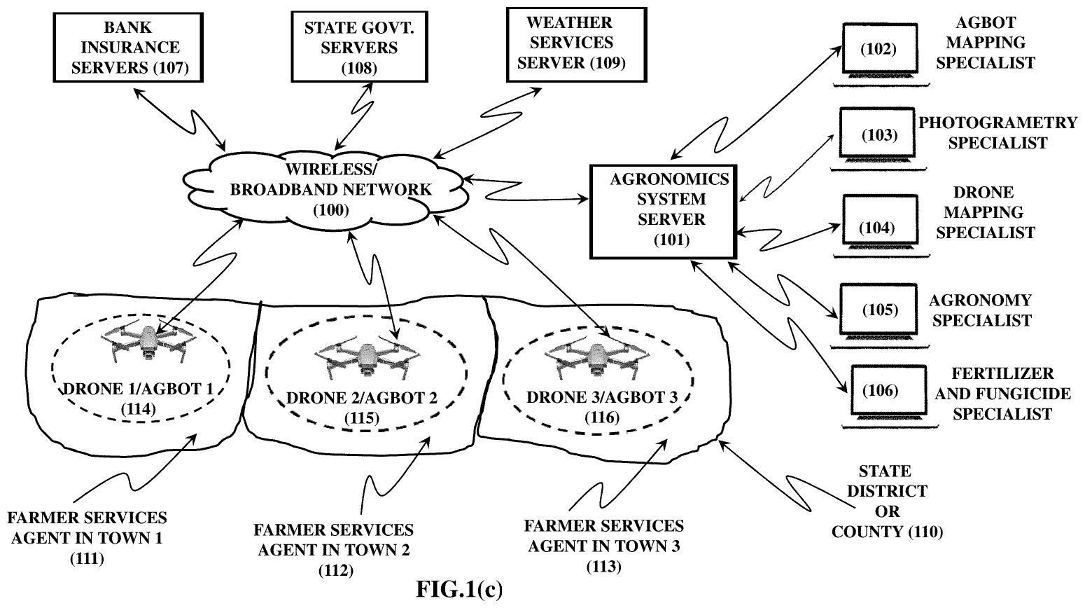

Embodiment of a system to provide precision agriculture methods to small farmers with no access to knowledge, technology know how, and affordable equipment is shown in FIG. 1(a). The map of entire area is divided into a 10 km hexagonal cellular structure. Cells can be hexagon circular or any shape to cover the area of farmland in a town. Modern mini Drones and mini Agriculture Robots, AGBOTs are used perform all operations needed for precision agriculture. These drones are relatively inexpensive and easy to operate by an operator at a central Web Server, (101). All the drones used in a cell is housed at the Drone Pod Station (DPS), (114). The drones at the DPS are connected to a central Web Server, (101) via a Broadband Wireless Network, (100) which could be 4G, or 5G public or private network. Cell radius is function of drone's ability of transmitting reliable information to the drone controller base located at DPS. The router at the DPS is connected to drone application server located at the Web Server, (101). This allows Drone operator and others at the Web Server (101) to view all the information transmitted by drones.

FIG. 1 (b) gives block diagram of drones at the various DPSs and their connectivity to the central Web Server (101). Drone's controllers are connected to the Web Server (101) by router (220). Invention uses a Quad Copter mini Drone, (115), for general imaging and it is remotely controlled by its controller, (119). A multi spectral camera quad copter drone, (116), with its controller, (120), is used to multicolor images for photogrammetry. A spraying drone, (117), with its controller, (121) is used to apply fertilizer and pesticides to the crops. An AGBOT Drone, (118), with its controller, (122) is used to weed the crops. The AGBOT drone has a detachable AGBOT rover at its belly and has clipper and picker arms to clip or pick the weeds. It has built in AI/deep learning algorithm to differentiate crop from weeds. Weed image and the map is preloaded by the Web Server, (101) and Drone is flown to the start location of the field and AGBOT rover is decoupled to start weeding. The drone picks up the rover after weeding and returns to the DPS.

In this invention the farmer's village will have a local Farmer's Service Agent, FSA, who is trained to operate DRONEs and AGBOTs. The FSA will service using a DPS, a cellular cluster of farms in villages in a Tehsil of a district in that state. FSA in each area manages the DPS's DRONEs and AGBOTs to provide services to farmer. FSA works with the agriculture agronomist, who use server based applications to guides the farmer at every stage of the crop. DRONE fitted with multi spectral camera, using remote control Drone operator at the central server, generates photogrammetry images of the farmer's field at the various time during the crop growth season, starting from sowing to harvesting. And these images help Agronomist advice the farmer through FSA, crop health and projected yield, right time and area with right fertilization, irrigation. Agronomists at the Agronomics System Server (101) directs the FSA to ready appropriate DRONE to fertilize the field and AGBOT drone to remove weeds without hurting the crop. All this is done remotely with the help of specialists at the central server. The FSA becomes the field agent for the farmer as per the direction of specialist at the central server. Programming of DRONEs and AGBOTs for them to perform a service in the farmer's field is all done at the central server and FSA just manages the DPS to prepare proper DRONE for the operator at the server to perform appropriate operation needed. Specialists at the central server provide all knowledge needed to manage a crop. And they watch whole operation in real time on their laptop terminals. DRONE with a range of ten kilometers and operation time of half hour is more than enough to service many farms in a cellular area. A cellular area which covers cluster of farms in a Tehsil is connected to the server over a wireless or broadband internet. These DRONE are easy to operate and quite reliable and not very expensive to own. This FSA model provides technical jobs in the villages, and will compliment farmers with no education or little education. The Yield forecast data generated at the server can be shared with the state government for them to plan and System can keep on updating these numbers as plants matures until fully harvested. System can quickly generate crop damage data from the drone video images as well as Photogrammetry images to assess the damages, during hail storm, floods and drought, for each farmer and share with government and insurance agencies for them to provide timely compensations.

A detailed block diagram of an embodiment of System of this invention is given in FIG. 1(c). A District or county (110) in a state has multiple Tehsils (111), (112), (113) and typically a Tehsil has six to twenty or more villages under one administrative head. The block diagram shows a District with three Tehsils. Each Tehsil has a Farmer's Service Agent, FSA. FSA is trained to provide services to farmers in a DPS, a cellular cluster of all villages. It has access to DRONEs and AGBOTs and a laptop, a smartphone and works under the direction of an Agronomists and other Specialists, (102), (103,104), (105,106), connected with the Server, (101), with all farm management applications. An agronomist is assigned to each farmer, who coordinates with other specialists and advise the farmer with timely advice on the crop. FSA becomes the hand, ears and eyes for the remote specialists during the launch of a Drones or AGBOT, (114), FSA will make sure the DRONE or AGBOT are fully charged, have memory card installed, and connected to the specialists laptop at the server, for them to start scheduled service like—mapping the farmer's field, seeding a field, taking multi spectral radiometric images of the field, fertilizer or pesticide applications. And DPS's controllers uploads the detailed pictures of the service to the server, 101, for specialists to analyze and advice the farmer. Since these operations only take few minutes at the field, it is easy for one FSA to cover all the villages in a Tehsil. Laptop used by the FSA has all data on each farmer's field and reports issued by the specialists, and crop Normalized Difference Vegetation Index, NDVI files, and Maps for DRONE and AGBOT. This is used to explain the farmer and acts as a temporary back up if FSA cannot get good connectivity to the server in the field.

Agronomists System Server, 101, has all the applications and data base on all farmers, like Farm Maps, Farmers Field's multi spectra images at various point of time during crop growth to create Normalized Difference Vegetation Index, NDVI, and images. These images are used by the specialist to analyze using remote sensing measurements to assess the plant growth, spot fertilization, spot irrigation and crop yield during various phase of crop plant growth. DRONE images from multi spectral radiometric camera are used to generate the NDVI images using software resident in the Server. The server also keeps track of weather data in each area and stores for each farmer.

Data analytics and statistics is the key to understand how agriculture works and it is very much missing in most of the farming in every countries. Currently not much is known about what is the amount of fertilizer, herbicides, pesticides farmers have used to grow the crops, which is dangerous as it jeopardizes public health. The system in this invention with its data analytic tools and drone based NDVI will precisely control fertilization and pesticide applications, yield statics and other statics necessary for good agriculture practices.

System generates and shares yields data with government agencies and helps them in forecasting yield at different point of crop's growth. The Server uses images before a calamity and after a calamity to assess damage to farmer's crop and shares this data with government agencies responsible to disperse compensation to the farmers. It could be a bank or any other insurance agency. Predictive analytic tools used is going to help farmers and country to quickly assess the loss to the farmers and country.

The server has resident application for farmer's education Package of Practices (POP) of various crops such as wheat, lentils, seeds, fruits etc. The system can extract data of all cross requirements, it's package of practice (POP) then use of fertilizers and pesticides can be controlled very effectively. For example say one wants to grow wheat, then there is POP for that, which shows when to grow, how to prepare a field, what type of seeds to purchase, what fertilizer and pesticide is applicable, what kind of disease can occur in that weather and how to control it. This will help farmers to understand their land, this data can save tones of fertilizer, pesticide to be wasted on the farms. And it will help end consumers with quality product.

This educational material, POP, will advise farmers exactly when to seed, when and type of fertilizer, time for irrigation and harvesting for each type of crop. AI tools in the server are used to assess crop infestation, soil analysis, crop irrigation and yield prediction. Soil data provided by the system help farmers to spend less on unnecessary cost and that will reflect on the farmers' profitability. Data of irrigation, fertilizer, pesticides, inter culture, intercropping, weather, soil, rain, seeds, market in combination will help farmers to take decisions on their crop very effectively. FSA becomes adviser and educator to the farmer using System's tools.

Advances in semiconductor technology has deflated the cost as well sizes of DRONEs. Agriculture mini DRONEs with multi spectral camera are available and easy to operated and have flying time of half an hour. These DRONEs have GPS, Gimbal stabilization of camera and radiometric measurement. These DRONEs offer flying range of seven to ten kilometer in the frequency band of 2.4 and 5.8 GHz and can cover easily twenty acres of field in less than few minutes. Which means it can cover average of five to ten farms in few minutes. These agriculture DRONEs also come with attachment for dispensing fertilizers and pesticides. These DRONEs are used at every cellular DPS center in the invention and FSA can easily use them as everything is Autonomous once their task is loaded by the Server and DRONE gets go to fly from the remote operator at the Server. These DRONEs can be fixed wing or quadcopter. These DRONEs can also be multi-copters. FSA can also watch the operation on its smartphone and make sure the DRONE starts at the desired location of the farmer's field, as mapped by the drone operator at the server. The DRONE returns to the DPS location after performing the service. The DRONE Map operator may choose to map multiple farms in that area with one sweep if it's going to perform same service for all the farmers.

Agriculture Robots have been used in picking fruits, vegetables and grapes by large farmers with thousand acres of field. Their cost is high and cannot be used by most farmers and growers. This invention uses a new class of mini AGBOT rovers Drones less than a shoe box size, which uses technology similar to DRONEs but moves in the field autonomously capable of traversing variable conditions in a crop field. These mini robots have built in machine learning and deep learning capability to recognize weed from real plant stalk and a build in clipper/puller arm to get rid of weeds. It will roam around the field like ant and weed out the field. There can be multiple of these mini AGBOTs roaming in the field working autonomously and collaborate with each other to weed fields. Deep learning algorithm can be remotely programmed for different weeds found in the area. Use of these mini AGBOT rovers would not require use of herbicide as weeds develop resistance to them as well as it can be only applied before a crop canopies and shadows the ground beneath it. And once the crop has reached to this point big farm machinery can cause damage to the growing plant. Also big equipment cannot reach between the plants after they have grown to certain point. A mini Drone with AGBOT fitted in the belly with ability to attach and detach AGBOT for weeding will relieve farmers from laborious task of weeding. These Rovers can be remotely programmed to add other applications like soil analysis at various spots in the field, which allows Agronomist to assess need for fertilization and irrigation.

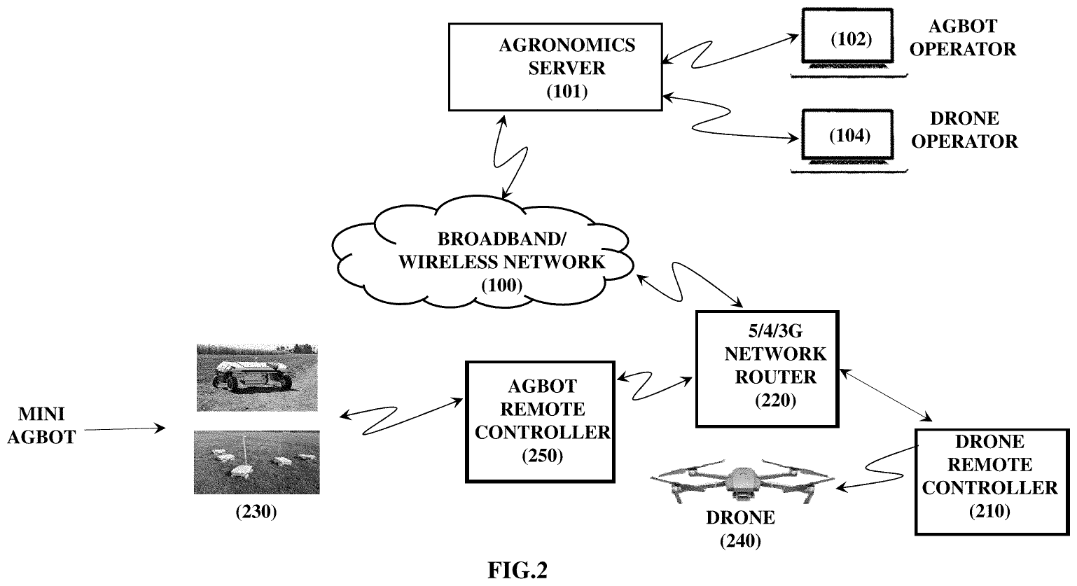

FIG. 2 of the invention shows an embodiment with a DRONE, (240), and a Mini AGBOT Drone, (230), at a DPS, connected by wireless means to their respective remote controllers, (210, 250), which are connected to a cellular 5G/4G/3G broadband repeater router, (220), thus providing connectivity to AGRONOMICS SERVER, (101), These remote controllers are used by operators (104) and (102) at the server, (101). The DPS can be mounted inside a vehicle which will provide power to operate them as well charge batteries installed in the robots and drone. In another embodiment these can be fitted on a motor bicycle with ease of plying it on the farms.

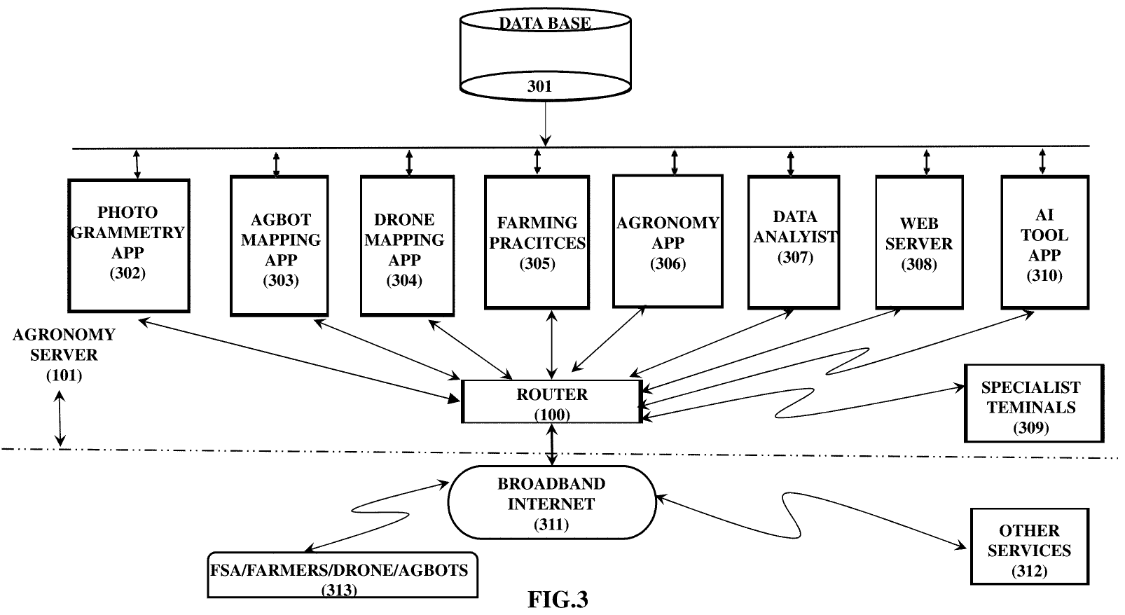

FIG. 3 of the invention gives a functional view of various applications running on the System Server, (101). These application servers can be a stand-alone server or in the cloud platform running these applications supported by the server's operating system. Drone mapping application, (304), is used to map a farmer's field and is used by other applications to operate a DRONE for various services in the field. AGBOT mapping application, (303), is used by the specialist service operators when using an AGBOT. Mapping applications allows specialists understand the topology of farmer's field, its gradient. The gradient information is very useful while planning the irrigation of the crop to avoid over watering. DRONE with multi spectra camera captures RGB and far infrared images of the crop, which allows Photogrammetric application software, (302) to perform relative biomass analysis, drought stress, irrigation scheduling, predicting agricultural production, monitoring nutrition, pest and diseases affecting the photographed crops. And this allows agronomist to suggest farmer appropriate steps for remedy. This approach is called precision agriculture than the traditional one. System takes these images periodically to monitor the crops and stores in the system for future data driven analysis using AI and analytic tools, (307), (310) resident in the server.

Database server, (301), stores all the data on each client farmer past and present for any kind of data analytic needed by any authority private or public. Web Server, (308), is used for scheduling various service to a client farmer, alerting FSA with scheduled services creating report to the client farmers at the end of each service, communicating with other servers, and streaming educational videos to the farmers. Specialist can send alert messages to farmers for their attention. It handles all security access control to the system to protect client farmer's data.

This Invention is also applicable to support medium to large size farmers for precision agriculture. These farmers can subscribe to the system services with the inventions distributed design to cover their farm acreage with multiple DPSs supported by System's FSA. And alleviate need for hiring dedicated staff and very expensive equipment for precision farming.

What is claimed is:

1. A Web Server based distributed cellular system and method, using low cost mini Drones and mini Agriculture Robot Drones, to offer twenty first century precision agriculture services to small farmers with little or no technical and educational skills and practicing traditional agriculture, the system comprising:
multiple seven to ten kilometers radius cells covering the entire village's farmers land, and each cell comprising;
at least one mini multi copter air drone for imaging and mapping farmers land,
at least one multi spectral camera mini drone, to collect soil and crop Red Green Blue (RGB) and far infrared images,
at least one spraying mini drone with capability to spray fertilizer and pesticides,
at least one mini agriculture robot rover mini drone with built in artificial intelligence to detect weeds from crop plants, soil analysis, and
at least a single or multiple central Agronomics Web Server connected to all the drone devices in every cell in the system over a broadband public or private wireless network comprising;
a drone mapping server, an agriculture robot drone mapping server, a photogrammetry application server, an agronomy server, a data analytics and AI tool server, a farmer practice server, a web server with interface to other services, and
a data base server for farm applications and farmers land data.

2. The system of claim 1 drones are used for seeding, selective fertilization, selective fungicide application without farmer owning any drone or operating one.

3. The multi spectral camera drone of claim 1 is used by the agronomists at the server to generate images of farmer's crop to recommend farmer selective irrigation, plant health, projected crop yield, plant disease, and best time to harvest.

4. The system of claim 1 uses farmer's crop images with data analytics and AI tools to predict crop yield, crop damages due to natural disasters and diseases, and shares this data with appropriate agencies and farmer.

5. The mini agriculture robot rover drone of claim 1 is remotely downloaded with weed route by the Agronomics Server with the weed images for robot to pick or clip weeds using its deep learning algorithm.

6. The mini agriculture robot of claim 1 is downloaded with deep learning algorithm for soil analysis and Agronomist at the server uses this data as well data obtained by photogrammetry to advice farmer for spot irrigation and fertilization.

7. The package of practice (POP) of claim 1 allows farmer to learn farming a crop, and cost benefit returns from crop.

8. The system of claim 1 uses Specialists at a central web based server, with all Agronomics management, Photogrammetric, mapping, weather of the day, data analytics, and AI applications. These operations are assisted by a farmer's service agent with DRONEs and AGBOTs at the farmer's field.
